(19) United States
(12) Patent Application Publication
(10) Pub. No.: US 2020/0285324 A1
(43) Pub. Date: Sep. 10, 2020

(54) CHARACTER INPUTTING DEVICE, AND NON-TRANSITORY COMPUTER READABLE RECORDING MEDIUM STORING CHARACTER INPUTTING PROGRAM

(71) Applicant: KYOCERA Document Solutions Inc., Osaka (JP)

(72) Inventor: Tadaaki AKIMOTO, Osaka-shi (JP)

(73) Assignee: KYOCERA Document Solutions Inc., Osaka (JP)

(21) Appl. No.: 16/806,633

(22) Filed: Mar. 2, 2020

(30) Foreign Application Priority Data
Mar. 6, 2019 (JP) 2019-040791

(51) Int. Cl. G06F 3/023; G06F 40/242; G06F 40/30

(52) U.S. Cl. CPC G06F 3/0237; G06F 40/30; G06F 40/242

(57) ABSTRACT

A character inputting device includes a storing part, a category classifying part, a conversion candidate obtaining part, and a conversion candidate displaying part. The storing part stores a word dictionary registering words and category-classified dictionaries registering respective peculiar words to categories. The category classifying part classifies the category about an electronic document and selects the category-classified dictionary corresponding to the category. The conversion candidate obtaining part, when a character storing is inputted or selected to the electronic document, obtains conversion candidates to the character storing on the basis of the words in the word dictionary and the selected category-classified dictionary. The conversion candidate displaying part makes a displaying part display the obtained conversion candidates in an order based on a display priority of each word while setting the display priority of the word in the selected category-classified dictionary higher than the display priority of the word in the word dictionary.

### INCORPORATION BY REFERENCE

This application is based on and claims the benefit of priority from Japanese Patent application No. 2019-040791 filed on Mar. 6, 2019, the entire contents of which are incorporated herein by reference.

### BACKGROUND

The present disclosure relates to a character inputting device inputting a character in accordance with operation of a creator creating an electronic document, and a non-transitory computer readable recording medium storing a character inputting program.

An information processing device, such as a personal computer, a mobile phone terminal, a smartphone or a tablet terminal, has a function creating an electronic document, such as a novel, an essay, a business related document, a mail or a chat, and works as a character inputting device inputting a character in the electronic document being created in accordance with operation of a creator. The character inputting device has assistance functions, such as character conversion using a word dictionary and autocomplete, in order to facilitate creation of the electronic document. In addition, the character inputting device has a function displaying a conversion candidate of kana-kanji conversion with regard to an inputted character or a conversion candidate of predictive conversion with regard to the inputted character on the basis of a word use history in order to complement the assistance functions.

For example, there is a character conversion system of a mobile phone terminal as a program of a conventional character inputting device. The character conversion system includes a character predictive conversion processing part, a relationship obtaining processing part, a relation consideration display order determination processing part, a character string output processing part, a conversion character determination processing part, and a relationship information update processing part. The character predictive conversion processing part generates a conversion candidate from a word dictionary part in consideration of a use frequency or the like on the basis of a predictive conversion system when a character string to be converted is inputted from the character inputting device. The relationship obtaining processing part acquires a relationship between a character inputting person and a sender from a mail address inputted at the time of creating an electronic mail. The relation consideration display order determination processing part determines a display order of predictive conversion candidates and creates a relation consideration predictive conversion candidate list in consideration of acquired relationship with the sender. The character string output processing part outputs the relation consideration predictive conversion candidate list to a display part. The conversion character determination processing part determines whether a conversion character is selected from the displayed relationship consideration predictive conversion candidate list. The relationship information update processing part performs, when the conversion character is selected, learning in the predictive conversion system in consideration of the use frequency or the like after updating a relationship of the selected conversion character.

In the conventional character inputting device, when a given creator performs creation work of the electronic document about a given kind (field), the conversion candidates displayed in accordance with to the character depends on the use history in the character inputting device. That is, as the conversion candidate in accordance with to a given character, the conversion candidate with a more recent use date or the conversion candidate with a higher use frequency is displayed high. For example, when a travel related electronic document is created after a medical related electronic document is created, the conversion candidate stored for the former is preferentially displayed at the time of work for the latter. Therefore, it is feared that the creation work of the electronic document becomes complication.

### SUMMARY

A character inputting device of the present disclosure includes a storing part, a category classifying part, a conversion candidate obtaining part, and a conversion candidate displaying part. The storing part stores a word dictionary, in which a plurality of words are registered, and a plurality of category-classified dictionaries, in which respective peculiar words to a plurality of categories are registered. The category classifying part classifies the category with regard to an electronic document and selects the category-classified dictionary corresponding to the category. The conversion candidate obtaining part, when a character storing is inputted or selected with regard to the electronic document, obtains one or more conversion candidates corresponding to the character storing on the basis of the word registered in the word dictionary and the word registered in the category-classified dictionary selected by the category classifying part. The conversion candidate displaying part makes a displaying part display the one or more conversion candidates obtained by the conversion candidate obtaining part in an order based on a display priority of each word while setting the display priority of the word registered in the category-classified dictionary selected by the category classifying part higher than the display priority of the word registered in the word dictionary.

In a non-transitory computer readable recording medium stores a character inputting program in an information processing device of the present disclosure, the character inputting program makes a computer of the information processing execute a first step, a second step, a third step, and a fourth step. A first step stores a word dictionary, in which a plurality of words are registered, and a plurality of category-classified dictionaries, in which respective peculiar words to a plurality of categories are registered. The second step classifies the category with regard to an electronic document and selects the category-classified dictionary corresponding to the category. The third step, when a character storing is inputted or selected with regard to the electronic document, obtains one or more conversion candidates corresponding to the character storing on the basis of the word registered in the word dictionary and the word registered in the category-classified dictionary selected by the category classifying part. The fourth step makes a displaying part display the one or more conversion candidates obtained with regard to the character string in an order based on the display priority of each word while setting the display priority of the word registered in the category-classified dictionary selected with regard to the electronic document higher than the display priority of the word registered in the word dictionary.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a block diagram showing a character inputting device according to an embodiment of the present disclosure.

FIG. 2 is a flowchart showing a converting operation of a character string in the character inputting device according to the embodiment of the present disclosure.

### DETAILED DESCRIPTION

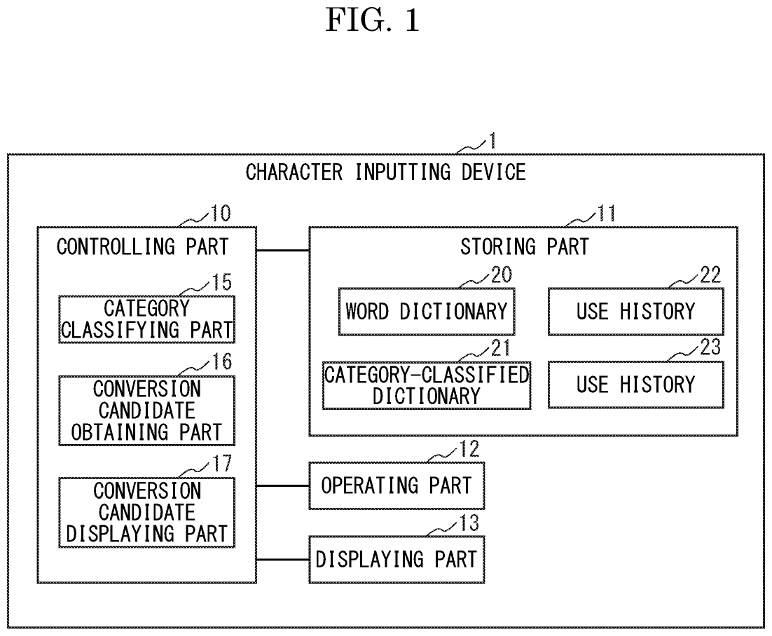

A character inputting device 1 according to an embodiment of the present disclosure will be described with reference to FIG. 1.

The character inputting device 1 is, for example, an information processing device, such as a personal computer, a mobile phone terminal, a smartphone or a tablet terminal, and has a function inputting a character in the electronic document being created in accordance with operation of a creator (e.g. a creator of an electronic document). The character inputting device 1 is used for inputting the character when the information processing device executes a document creating program for creating an electronic document, such as a novel, an essay or a business related document, a mail creating program for creating a mail, a message creating program for creating a message contributed in an SNS (Social Network Service) or the like. Incidentally, creating of the electronic document contains new creating and editing.

The character inputting device 1 has character inputting assistance functions, such as character conversion using a word dictionary 20 or a category-classified dictionary 21 described later and autocomplete, in order to facilitate creation of the electronic document. In addition, the character inputting device 1 has a function displaying a conversion candidate of kana-kanji conversion with regard to an inputted or selected one or more characters (hereinafter, called as an inputted character string) or a conversion candidate of predictive conversion with regard to the inputted character string on the basis of word use histories 22 and 23 in order to complement the character inputting assistance functions.

The character inputting device 1 includes a controlling part 10 composed of a CPU (Central Processing Unit) or the like, and a storing part 11 composed of a ROM (Read Only Memory), a RAM (Random Access Memory), a hard disc and others. The storing part 11 is a non-transitory recording medium readable by the controlling part 10 being a computer, and stores control program and control data controlled by the controlling part 10.

For example, the storing part 11 stores a document creating program and a character inputting program described later, and stores the word dictionary 20 and a plurality of category-classified dictionaries 21 used in the character inputting program.

In the word dictionary 20, a plurality of words, particularly various general words used in the character inputting program are registered. The word dictionary 20 registers each word in association with Japanese reading (kana indicating pronunciation of kanji) and enables searching of the word on the basis of Japanese reading. In a case of performing kana-kanji conversion with regard to a given character string, by using the word dictionary 20, the word (a homonym) having the same pronunciation as the character string can be searched as the conversion candidate. Moreover, in a case of performing predictive conversion with regard to an undetermined character string (starting characters in the middle of input of a character string), by using the word dictionary 20, the word containing starting characters having the same pronunciation as the undetermined character string can be searched as the conversion candidate.

Moreover, the storing part 11 stores association of a given Japanese reading (i.e. character string) with one or more words (i.e. conversion candidates) searched from the word dictionary 20 in accordance with this Japanese reading. The association of the Japanese reading with the one or more words may be stored in the word dictionary 20 or may be stored in the other table or the like. Further, incidental to the association of the Japanese reading with the one or more words, display priority when each word is displayed as the conversion candidate on a displaying part 13 is set for each word and stored (in the storing part 11). In addition, incidental to the association of the Japanese reading with the one or more words, the fact that each word is selected in kana-kanji conversion or predictive conversion is stored as the use history 22 of each word in the word dictionary 20 (in the storing part 11). The use history 22 of each word contains, for example, a final use date or a use frequency.

The plurality of category-classified dictionaries 21 are provided in accordance with a plurality of different categories, respectively. In each category-classified dictionary 21, the words peculiar to each corresponding category are registered. Incidentally, each category-classified dictionary 21 registers the words similar to the word dictionary 20, and the word in each category-classified dictionary 21 may be overlapped with the word in the word dictionary 20 or may be an individual word not registered in the word dictionary 20. In the category-classified dictionary 21, not only the predetermined word, but also the word set by a user or the word combined in past single kanji conversion. That is, the category-classified dictionary 21 works as a learning dictionary of the user.

Moreover, the storing part 11 stores association of a given Japanese reading (i.e. character string) with one or more words (i.e. conversion candidates) searched from each category-classified dictionary 21 in accordance with this Japanese reading. The association of the Japanese reading with the one or more words may be stored in each category-classified dictionary 21 or may be stored in the other table or the like. Further, incidental to the association of the Japanese reading with the one or more words, display priority when each word is displayed as the conversion candidate on the displaying part 13 is set for each word and stored (in the storing part 11). In addition, incidental to the association of the Japanese reading with the one or more words, the fact that each word is selected in kana-kanji conversion or predictive conversion is stored as the use history 23 of each word in each category-classified dictionary 21 (in the storing part 11). The use history 23 of each word contains, for example, a final use date or a use frequency.

For example, the storing part 11 includes the plurality of category-classified dictionaries 21 respectively corresponding to a plurality of different fields while treating each field of the electronic document as each category. For example, in the field of the electronic document, there are various technical fields, such as a medical field, a mechanical field, an electrical field, a software field, a physical field, a chemical field and a biological field, various interest field, such as a travel field and a sport field, and other various fields, and each category-classified dictionary 21 corresponding to each field, i.e. each field-classified word dictionary is provided. In each field-classified word dictionary, the words peculiar to each field are registered.

Moreover, the storing part 11 includes the plurality of category-classified dictionaries 21 respectively corresponding to a plurality of different fields while treating skill, experience or level of the creator of the electronic document (skill level in each field of the electronic document) as each category. For example, in each field of the electronic document, the skill level of the creator of the electronic document is classified into various skill levels, such as a beginner class, an intermediate class and an advanced class, and each category-classified dictionary 21 corresponding to each skill level, i.e. each skill level-classified word dictionary is provided. Each skill level-classified word dictionary contains the words peculiar to each skill level, for example, may contain the words of larger vocabulary or may contain more specialized words or more advanced words, as a class of the skill level becomes higher in comparison with the beginner class.

Further, the storing part 11 includes the plurality of category-classified dictionaries 21 respectively corresponding to a plurality of different creator types while treating a creator type, such as age or sex, of the creator of the electronic document as each category. As each category-classified dictionary 21 corresponding to each creator type, i.e. each creator type-classified word dictionary, for example, an age-classified word dictionary according to age of the creator or a generation-classified word dictionary according to generation of the creator may be provided, or a sex-classified word dictionary according to sex of the creator may be provided. Alternatively, as the creator type-classified word dictionary, a combination-classified word dictionary according to combination of age or generation and sex of the creator may be provided. Each creator type-classified word dictionary contains the words peculiar to each age or each generation, or the words peculiar to each sex, for example, may contain prevalent words in each age or each generation, or prevalent words in each sex.

Moreover, the character inputting device 1 includes an operating part 12 and the displaying part 13, and the controlling part 10 controls the operating part 12 and the displaying part 13 on the basis of the control program and the control data stored in the storing part 11. For example, the controlling part 10 executes the document creating program stored in the storing part 11 to control the operating part 12 and the displaying part 13.

In addition, when the document creating program is executed, the controlling part 10 executes the character inputting program stored in the storing part 11 to provide the above-described character inputting assistance functions, and then, to input the character to the electronic document. Further, the controlling part 10 executes the character inputting program stored in the storing part 11 to work as a category classifying part 15, a conversion candidate obtaining part 16 and a conversion candidate displaying part 17 in order to complement the character inputting assistance functions.

The character inputting program makes the controlling part 10 (computer) of the character inputting device 1 (information processing device) execute each process (step), and is composed of a software operating on the personal computer, an application operating on the smartphone, or the like.

The operating part 12 is composed of an input device, such as a keyboard or a pointing device, and receives operation of the user and transmits this operation to the controlling part 10. The displaying part 13 is composed of a display device, such as a liquid crystal display, and is controlled by the controlling part 10 to display respective kinds of screens. Alternatively, the operating part 12 and the displaying part 13 may be composed of and a touch pad and a liquid crystal panel, respectively, and thereby, be composed as an integrated touch panel. Hereinafter, operation of the user indicates operation of the user via the operating part 12, unless otherwise stated.

The controlling part 10 executing the character inputting program receives character inputting in accordance with the operation of the user via the operating part 12 to treat inputted characters as the inputted character string. The controlling part 10 executing the document creating program makes the displaying part 14 display a creating screen for the new creating or editing electronic document. Moreover, the controlling part 10 executing the character inputting program while executing the document creating program makes the creating screen for the electronic document display the character string inputted by the operating part 12. On the creating screen for the electronic document, the character being edited can be selected by operation of the operating part 12, and the controlling part 10 treats the selected character as the inputted character string.

Next, the category classifying part 15, the conversion candidate obtaining part 16 and the conversion candidate displaying part 17 will be described.

The category classifying part 15 classifies the category of the electronic document being created while the character inputting program is executed so as to assist creation of the electronic document. For example, when a file of the electronic document is opened or whenever a given time is elapsed while creating the electronic document, the category classifying part 15 classifies the category in timing when character inputting or document creating is not disturbed. Subsequently, the category classifying part 15 selects the category-classified dictionary 21 corresponding to the classified category as the category-classified dictionary 21 used for the character inputting program.

Concretely, the category classifying part 15 extracts the word or a sentence used in a body of the electronic document being created, and analyzes semantic contents or the use frequency of the word or the sentence to classify the category of this electronic document. That is, the category classifying part 15 periodically analyzes the semantic contents or the use frequency of the word or the sentence used in the electronic document to classify the category of this electronic document. Thereby, after detecting the category, such as the field, of the electronic document being created, it is possible to further narrow the category, such as the field, on the basis of the word or sentence contents used in the electronic document advanced in creating work.

For example, if the use frequency of the word indicating a given field is relatively high, the field on which this word depends can be classified as the category. Moreover, as the use frequency of the specialized word or the advanced word becomes higher, the higher skill level can be classified as the category. Further, a school year of the creator as a student can be decided by analyzing use condition of word or kanji defined in the government curriculum guidelines, or the age or the generation, or the sex of the creator can be decided by analyzing use condition of the prevalent word, and then, the creator type on the basis of such a decided result can be classified as the category.

Incidentally, because new electronic document has little body contents, information for making classification of the category of the new electronic document is little, but as creating work of the new electronic document is advanced, contents of the new electronic document is increased, and accordingly, information for making classification of the category of the new electronic document is increased, and therefore, the category classifying part 15 can improve accuracy of category classification.

Moreover, the category classifying part 15 extracts the word used for a file name, a storing folder name, a file property or the like of the electronic document being created, and analyzes the semantic contents of this word to classify the category of this electronic document.

Incidentally, a program or a table used for classifying the category may be stored in the storing part 11 or may be provided in an external device (e.g. a server or a database stored in a cloud) and the character inputting device 1 communicates with the external device to make the external device classify the category.

The conversion candidate obtaining part 16 obtains one or more conversion candidates from the word dictionary 20 and the category-classified dictionary 21 selected by the category classifying part 15 on the basis of the inputted character string when the inputted character string is inputted or selected in accordance with operation of the operating part 12. In a case where kana-kanji conversion is performed, the conversion candidate obtaining part 16 searches the word having Japanese reading of the same pronunciation as the inputted character string as the conversion candidate from the words registered in the word dictionary 20 and the category-classified dictionary 21. Moreover, in a case where predictive conversion is performed, the conversion candidate obtaining part 16 searches the word containing starting characters having Japanese reading of the same pronunciation as the inputted character string as the conversion candidate from the words registered in the word dictionary 20 and the category-classified dictionary 21. Incidentally, if overlapped words are searched from the word dictionary 20 and the category-classified dictionary 21, the conversion candidate obtaining part 16 preferentially treats the word of the category-classified dictionary 21 as the conversion candidate.

The conversion candidate displaying part 17 makes a candidate displaying area of the displaying part 13 display the one or more conversion candidates obtained by the conversion candidate obtaining part 16. At this time, the conversion candidate displaying part 17 may determine a display order of the one or more conversion candidates while setting the display priority of the word registered in each category-classified dictionary 21 higher than the display priority of the word registered in the word dictionary 20. For example, the conversion candidate displaying part 17 may display the conversion candidate obtained from each category-classified dictionary 21 in a higher order in comparison with the conversion candidate obtained from the word dictionary 20. Alternatively, given weighting with regard to the display priority of the word registered in the word dictionary 20 may be set to the display priority of the word registered in each category-classified dictionary 21. Incidentally, the candidate displaying area may be displayed by pop-up near the inputted character string, or may be displayed in the vicinity of a keyboard of touch panel.

Moreover, the conversion candidate displaying part 17 obtains the use history 22 of each word in the word dictionary 20 and the use history 23 of each word in each category-classified dictionary 21 from the storing part 11 on the basis of Japanese reading of the inputted character string. Subsequently, the conversion candidate displaying part 17 determines the display order of the one or more conversion candidates on the basis of the use history 22 in the word dictionary 20 and the use history 23 in each category-classified dictionary 21. The conversion candidate displaying part 17 may display the conversion candidate with a more recent use date or the conversion candidate with a higher use frequency in a higher order.

In the character inputting device 1, if any conversion candidate is selected from the one or more conversion candidates displayed by the conversion candidate displaying part 17 by operation of the operating part 12, the selected conversion candidate is displayed as a determined character string on the creating screen for the electronic document and stored in the electronic document.

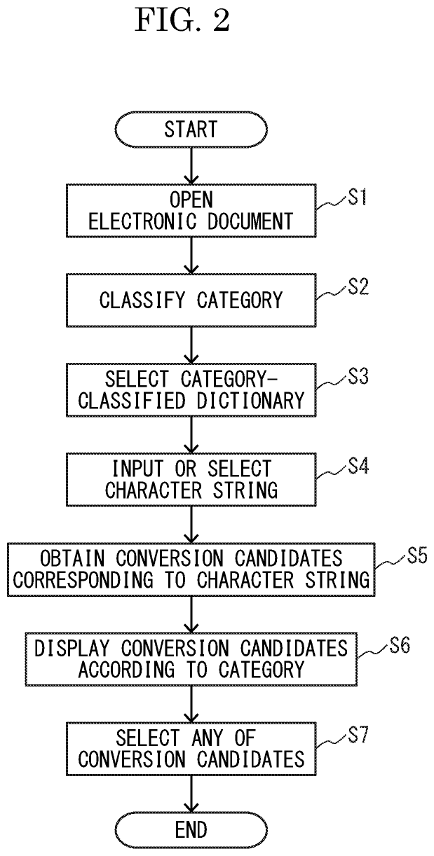

Next, converting operation of the character string by the character inputting device 1 will be described with reference to a flowchart in FIG. 2.

First, in the character inputting device 1, a file of the electronic document to be created is opened by the document creating program, and the electronic document is displayed on the creating screen of the displaying part 13 (step S1).

The category classifying part 15 classifies the category with regard to the electronic document being created (step S2), and selects the category-classified dictionary 21 corresponding to the classified category (step S3).

The character inputting device 1 receives inputting or selecting of the inputted character string in accordance with operation of the operating part 12 with regard to the electronic document being created (step S4).

The conversion candidate obtaining part 16 obtains one or more conversion candidates corresponding to the inputted character string from the word dictionary 20 and the selected category-classified dictionary 21 (step S5).

The conversion candidate displaying part 17 determines the display order of the one or more conversion candidates obtained by conversion candidate obtaining part on the basis of the use history 22 in the word dictionary 20 and the use history 23 in each category-classified dictionary 21 while setting the display priority of the word registered in each category-classified dictionary 21 higher, and makes the candidate displaying area of the displaying part 13 display the one or more conversion candidates (step S6).

The character inputting device 1 allows selecting of any conversion candidate from the one or more conversion candidates and treats the selected conversion candidate as the determined character string (step S7).

In accordance with the embodiment, as described above, the character inputting device 1 includes the storing part 11, the category classifying part 15, the conversion candidate obtaining part 16, and the conversion candidate displaying part 17. The storing part 11 stores the word dictionary 20, in which a plurality of words are registered, and a plurality of category-classified dictionaries 21, in which respective peculiar words to a plurality of categories are registered. The category classifying part 15 classifies the category with regard to the electronic document being created and selects the category-classified dictionary 21 corresponding to the category. The conversion candidate obtaining part 16, when the character storing is inputted or selected with regard to the electronic document, obtains one or more conversion candidates corresponding to the character storing on the basis of the word registered in the word dictionary 20 and the word registered in the category-classified dictionary selected by the category classifying part 15. The conversion candidate displaying part 17 makes the displaying part 13 display the one or more conversion candidates obtained by the conversion candidate obtaining part 16 in an order based on the display priority of each word while setting the display priority of the word registered in the category-classified dictionary 21 selected by the category classifying part 15 higher than the display priority of the word registered in the word dictionary 20.

In other words, in the embodiment, the character inputting program in the character inputting device 1 (information processing device) is stored in the storing part 11 being a non-transitory recording medium readable by the controlling part 10 being a computer, and makes the controlling part 10 of the character inputting device 1 execute a first step, a second step, a third step and a fourth step. The first step stores the word dictionary 20, in which a plurality of words are registered, and a plurality of category-classified dictionaries 21, in which respective peculiar words to a plurality of categories are registered. The second step classifies the category with regard to the electronic document being created and selects the category-classified dictionary 21 corresponding to the category. The third step, when the character storing is inputted or selected with regard to the electronic document, obtains one or more conversion candidates corresponding to the character storing on the basis of the word registered in the word dictionary 20 and the word registered in the category-classified dictionary selected by the category classifying part 15. The fourth step makes the displaying part 13 display the one or more conversion candidates obtained by the conversion candidate obtaining part 16 in an order based on the display priority of each word while setting the display priority of the word registered in the category-classified dictionary 21 selected by the category classifying part 15 higher than the display priority of the word registered in the word dictionary 20.

Thereby, in accordance with the character inputting device 1 of the present embodiment, the category-classified dictionary 21 suitable for the category with regard to the electronic document to be created is automatically selected, and the conversion candidates of kana-kanji conversion or predictive conversion are displayed in an order suitable for the category with regard to the electronic document. According to this, for the creator of the electronic document, it is possible to easily select a desired conversion candidate regardless of the category, and to improve complication of work. Thus, in accordance with the present disclosure, it is possible to effectively assist character inputting in creation of the electronic document regardless of the category of the electronic document.

Moreover, in the character inputting device 1 of the present embodiment, the storing part 11 stores the plurality of category-classified dictionaries 21 respectively corresponding to a plurality of fields while treating the fields of the electronic document as the respective categories. The category classifying part 15 classifies the field as the category on the basis of contents of the electronic document being created, and selects the category-classified dictionary 21 corresponding to the field.

Thereby, when creation of the electronic document is advanced, in accordance with variation of contents of the electronic document, such as the words or the sentence used in the electronic document, it is possible to narrow the field with high accuracy. In addition, if the work is switched between the electronic documents in different fields, it is possible to adapt the conversion candidate of kana-kanji conversion or predictive conversion or the category-classified dictionary 21 working as the learning dictionary to the field of the electronic document being created.

Moreover, in the character inputting device 1 of the present embodiment, the storing part 11 stores the plurality of category-classified dictionaries 21 respectively corresponding to a plurality of skill levels while treating the skill levels of the creator in the field of the electronic document as the respective categories. The category classifying part 15 classifies the skill level as the category on the basis of contents of the electronic document being created, and selects the category-classified dictionary 21 corresponding to the skill level.

Thereby, in accordance with contents or frequency of the words, the sentence or the like used in the electronic document, it is possible to automatically decide and learn the skill level of the creator of the electronic document, and to perform kana-kanji conversion or predictive conversion with a level according to the creator. For example, the creator in a beginner class can more easily create a document, and the creator in an advanced class can create a more specialized and advanced document.

Moreover, in the character inputting device 1 of the present embodiment, the storing part 11 stores the plurality of category-classified dictionaries 21 respectively corresponding to a plurality of creator types while treating the creator types of the creator of the electronic document as the respective categories. The category classifying part 15 classifies the creator type as the category on the basis of contents of the electronic document being created, and selects the category-classified dictionary 21 corresponding to the creator type.

Thereby, it is possible to record and learn word or kanji used in the electronic document, and to infer age or sex of the creator from a use tendency of word or kanji. Subsequently, it is possible to adapt an order displaying words being the conversion candidates to feature of the creator (creator type), and to assist kana-kanji conversion or predictive conversion in accordance with each creator. Therefore, for example, by heightening a display order of the conversion candidate of the prevalent word for a young creator, it is possible to facilitate selection of the prevalent word. By lowering a display order of the conversion candidate of unlearned word or kanji for a child creator, it is possible to facilitate selection of hiragana (Japanese syllabary characters), katakana (other Japanese syllabary characters) or the other easy word. Thus, it is possible to comfortably proceed creation of the electronic document for various creators.

Moreover, in the character inputting device 1 of the present embodiment, the conversion candidate displaying part 17 displays the one or more conversion candidates in an order based on the display priority and the respective use histories 22 and 23 of the one or more conversion candidates.

Thereby, since the conversion candidates are displayed in the display order in consideration of the use histories 22 and 23 of each word without biasing a priority order peculiar to the category, it is possible to suitably estimate the word desired by the creator and to display the estimated word.

Incidentally, the category classifying part 15 may classify one category from the field, the skill level or the creator type on the basis of the contents of the electronic document to select one category-classified dictionary 21, or may classify two or more categories to select two or more category-classified dictionaries 21.

Although the above-described embodiments have described about one example of the character inputting device and the non-transitory computer readable recording medium storing the character inputting program according to the present disclosure, the technical scope of the present disclosure is not limited to the embodiments.

Although, in the above-described embodiments, a case where a configuration of the present disclosure is applied in the character inputting device 1 being the information processing device, such as a personal computer, a mobile phone terminal, a smartphone or a tablet terminal, is described, in a different embodiment, the configuration of the present disclosure may be applied in the other information processing device working as the character inputting device 1, or the non-transitory computer readable recording medium storing the character inputting program installed in the other information processing device.

1. A character inputting device comprising:
a storing part storing a word dictionary, in which a plurality of words are registered, and a plurality of category-classified dictionaries, in which respective peculiar words to a plurality of categories are registered;
a category classifying part classifying the category with regard to an electronic document and selecting the category-classified dictionary corresponding to the category;
a conversion candidate obtaining part, when a character storing is inputted or selected with regard to the electronic document, obtaining one or more conversion candidates corresponding to the character storing on the basis of the word registered in the word dictionary and the word registered in the category-classified dictionary selected by the category classifying part; and
a conversion candidate displaying part making a displaying part display the one or more conversion candidates obtained by the conversion candidate obtaining part in an order based on a display priority of each word while setting the display priority of the word registered in the category-classified dictionary selected by the category classifying part higher than the display priority of the word registered in the word dictionary.

2. The character inputting device according to claim 1, wherein
the storing part stores the plurality of category-classified dictionaries respectively corresponding to a plurality of fields while treating the fields of the electronic document as the respective categories,
the category classifying part classifies the field as the category on the basis of contents of the electronic document, and selects the category-classified dictionary corresponding to the field.

3. The character inputting device according to claim 1, wherein
the storing part stores the plurality of category-classified dictionaries respectively corresponding to a plurality of skill levels while treating the skill levels of the creator in the field of the electronic document as the respective categories,
the category classifying part classifies the skill level as the category on the basis of contents of the electronic document, and selects the category-classified dictionary corresponding to the skill level.

4. The character inputting device according to claim 1, wherein
the storing part stores the plurality of category-classified dictionaries respectively corresponding to a plurality of creator types while treating the creator types of the creator of the electronic document to the respective categories,
the category classifying part classifies the creator type as the category on the basis of contents of the electronic document, and selects the category-classified dictionary corresponding to the creator type.

5. The character inputting device according to claim 1, wherein
the conversion candidate displaying part displays the one or more conversion candidates in an order based on the display priority and respective use histories of the one or more conversion candidates.

6. The communicating device according to claim 1, wherein
the category classifying part extracts the word or a sentence used in a body of the electronic document being created, analyzes semantic contents or a use frequency of the word or the sentence to classify the category of the electronic document, and after detecting the category of the electronic document being created, further narrows the category on the basis of the word or the sentence used in the electronic document advanced in creating work.

7. A non-transitory computer readable recording medium storing a character inputting program in an information processing device,
wherein the character inputting program makes a computer of the information processing execute:
a first step storing a word dictionary, in which a plurality of words are registered, and a plurality of category-classified dictionaries, in which respective peculiar words to a plurality of categories are registered;
a second step classifying the category with regard to an electronic document and selecting the category-classified dictionary corresponding to the category;
a third step, when a character storing is inputted or selected with regard to the electronic document, obtaining one or more conversion candidates corresponding to the character storing on the basis of the word registered in the word dictionary and the word registered in the category-classified dictionary selected by the category classifying part; and
a fourth step making a displaying part display the one or more conversion candidates obtained with regard to the character string in an order based on the display priority of each word while setting the display priority of the word registered in the category-classified dictionary selected with regard to the electronic document higher than the display priority of the word registered in the word dictionary.
